(19) United States
(12) Patent Application Publication
(10) Pub. No.: US 2016/0070214 A1
(43) Pub. Date: Mar. 10, 2016

(54) IMAGE FORMING APPARATUS

(71) Applicant: FUJI XEROX CO., LTD., Tokyo (JP)

(72) Inventors: Toko HARA, Kanagawa (JP); Yasumitsu HARASHIMA, Kanagawa (JP); Miho IKEDA, Kanagawa (JP); Takaharu NAKAJIMA, Kanagawa (JP); Koichiro YUASA, Kanagawa (JP)

(21) Appl. No.: 14/683,547

(22) Filed: Apr. 10, 2015

(30) Foreign Application Priority Data
Sep. 5, 2014 (JP) 2014-181114

(51) Int. Cl. G03G 15/20

(52) U.S. Cl. CPC G03G 15/2039

(57) ABSTRACT

An image forming apparatus includes a first image forming unit that uses a toner including a flat pigment, a second image forming unit that uses a toner not including a flat pigment, and a fixing unit that fixes a toner image formed on a recording medium by heat. In the image forming apparatus, a minimum fixing temperature of the toner including the flat pigment is lower than a minimum fixing temperature of the toner not including the flat pigment.

### CROSS-REFERENCE TO RELATED APPLICATIONS

This application is based on and claims priority under 35 USC 119 from Japanese Patent Application No. 2014-181114 filed Sep. 5, 2014.

### BACKGROUND

1. Technical Field

The present invention relates to an image forming apparatus.

2. Summary

An image forming apparatus according to an aspect of the present invention includes a first image forming unit that uses a toner including a flat pigment, a second image forming unit that uses a toner not including a flat pigment, and a fixing unit that fixes a toner image formed on a recording medium by heat. In the image forming apparatus, a minimum fixing temperature of the toner including the flat pigment is lower than a minimum fixing temperature of the toner not including the flat pigment.

### BRIEF DESCRIPTION OF THE DRAWINGS

Exemplary embodiments of the present invention will be described in detail based on the following figures, wherein:

FIG. 1 is a view schematically illustrating a structure of an image forming apparatus according to a first exemplary embodiment of the present invention;

FIG. 2 illustrates a structure of one of toner image forming units included in the image forming apparatus according to the first exemplary embodiment of the present invention;

FIG. 3A is a sectional view of a comparative example illustrating positions of flat pigment particles included in a toner image, and FIG. 3B is a sectional view illustrating the positions of the flat pigment particles included in a toner image formed by the image forming apparatus according to the first exemplary embodiment of the present invention;

FIG. 4A is a plan view of the comparative example illustrating the positions of the flat pigment particles included in the toner image, and FIG. 4B is a plan view illustrating the positions of the flat pigment particles included in the toner image formed by the image forming apparatus according to the first exemplary embodiment of the present invention;

FIGS. 5A and 5B are respectively a plan view and a side view illustrating one of the flat pigment particles included in a toner used in the image forming apparatus according to the first exemplary embodiment of the present invention;

FIG. 6A is a schematic view of the comparative example illustrating the toner image including the flat pigment particles, FIG. 6B is a schematic view illustrating a toner image including pigment particles other than the flat pigment particles formed by the image forming apparatus according to the first exemplary embodiment of the present invention, and FIG. 6C is a schematic view illustrating the toner image including the flat pigment particles formed by the image forming apparatus according to the first exemplary embodiment of the present invention;

FIG. 7 is a graph illustrating the relationship between a metallically glossy appearance and a minimum fixing temperature;

FIG. 8 is a schematic view illustrating a solid image used in measurement of the minimum fixing temperature (MFT);

FIG. 9A is a graph illustrating the relationship between a flop index (FI) and gloss, and FIG. 9B is a graph in which a range of the flop index around 7 illustrated in FIG. 9A is enlarged and a regression line is drawn;

FIG. 10 is a graph illustrating the relationship between the minimum fixing temperature and the gloss;

FIG. 11A is a schematic view of the comparative example illustrating the toner image including the flat pigment particles in which the heat amount is not increased when fixing the toner image, FIG. 11B is a schematic view illustrating a state of the image formed by the image forming apparatus according to a second exemplary embodiment of the present invention before the image is fixed and the toner including the flat pigment particles easily move, and

FIG. 11C is a schematic view illustrating the image illustrated in FIG. 11B having been fixed; and

FIG. 12 is a graph illustrating the relationship between the minimum fixing temperatures and the gloss of a silver toner (Si) and a toner of another color (K).

### DETAILED DESCRIPTION

### First Exemplary Embodiment

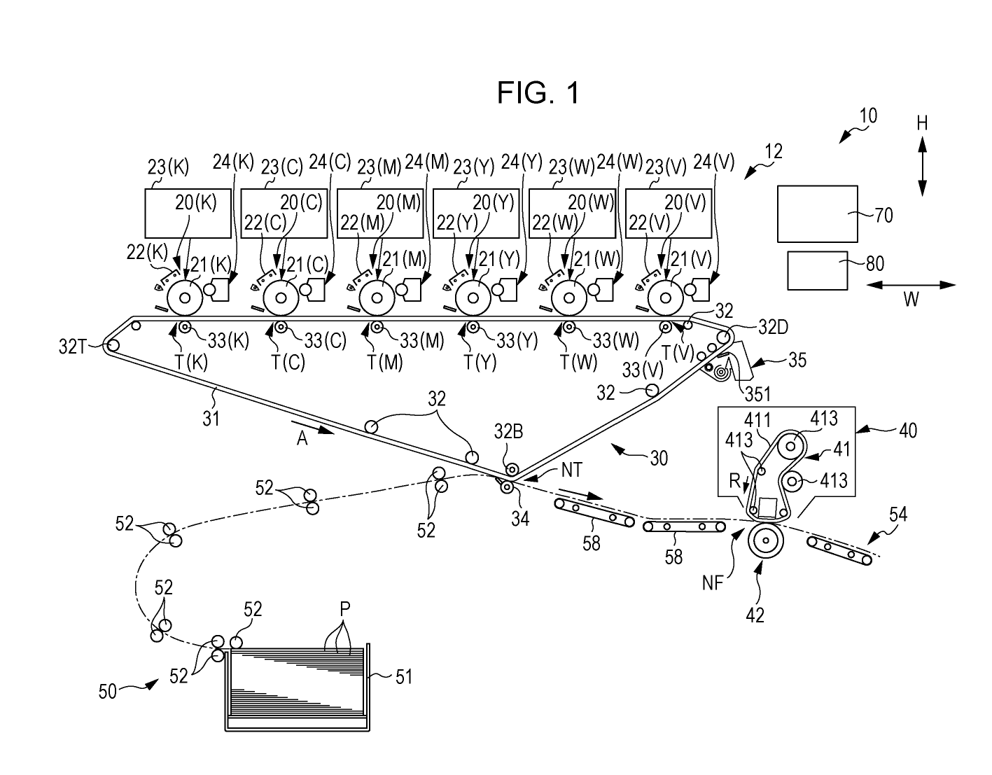

An example of an image forming apparatus according to a first exemplary embodiment of the present invention will be described with reference to FIGS. 1 to 11. In the drawings, a double-headed arrow H indicates the vertical direction and a double-headed arrow W indicates the horizontal direction which is the width direction of the apparatus.

### Configuration of Image Forming Apparatus 10

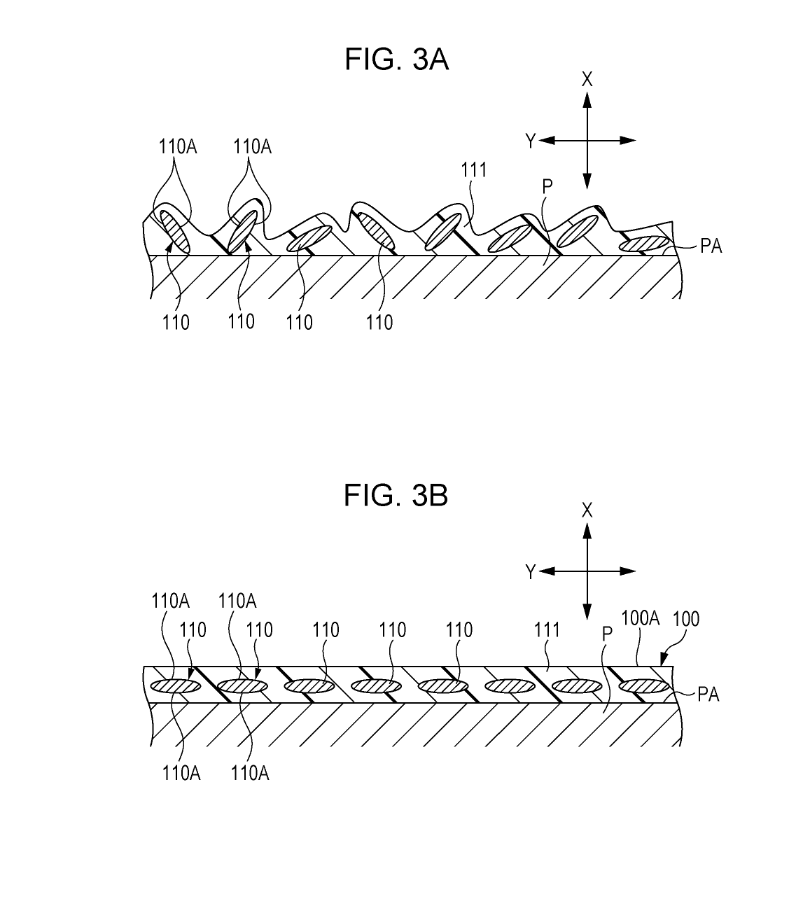

FIG. 1 is a schematic view of a configuration of an image forming apparatus 10 seen from the front side. As illustrated in FIG. 1, the image forming apparatus 10 includes an image forming section 12, a transport device 50, a controller 70, and a power source unit 80. The image forming section 12 forms images on sheet surfaces PA (see, for example, FIG. 3B) of a sheet-shaped recording media (sheet members) P such as sheets of paper with an electrophotographic method. The transport device 50 transports the recording media P. The controller 70 controls operations of components of the image forming apparatus 10. The power source unit 80 supplies power to the components of the image forming apparatus 10. Transport Device

As illustrated in FIG. 1, the transport device 50 includes a container unit 51 and plural transport rollers 52. The container unit 51 contains the recording media P. The transport rollers 52 transport each of the recording media P from the container unit 51 to a second transfer position NT, which will be described later. The transport device 50 further includes plural transport belts 58 and a transport belt 54. The transport belts 58 transport the recording medium P from the second transfer position NT to a fixing device 40. The transport belt 54 transports the recording medium P from the fixing device 40 toward a recording-medium ejection unit (not illustrated).

### Image Forming Section

The image forming section 12 includes toner image forming units 20, a transfer device 30, and the fixing device 40. The toner image forming units 20 form toner images. The transfer device 30 transfers the toner images formed by the toner image forming units 20 onto the recording medium P. The fixing device 40 applies heat and pressure to the toner images having been transferred onto the recording media P so as to fix the toner images onto the recording medium P.

The plural toner image forming units 20 are provided so that each of the toner image forming units 20 forms a toner image of a corresponding one of colors. In the present exemplary embodiment, the toner image forming units 20V, 20W, 20Y, 20M, 20C, and 20K of the following six colors are provided: a first special color (V), a second special color (W), yellow (Y), magenta (M), cyan (C), and black (K). Signs “V”, “W”, “Y”, “M”, “C”, and “K” illustrated in FIG. 1 represent the above-described colors.

In the present exemplary embodiment, the first special color (V) is a metallic color that adds metallic luster to an image. Specifically, a silver toner is used in the present exemplary embodiment. The second special color (W) is a user specific corporate color. The details of toners of respective colors will be described later.

### Toner Image Forming Units

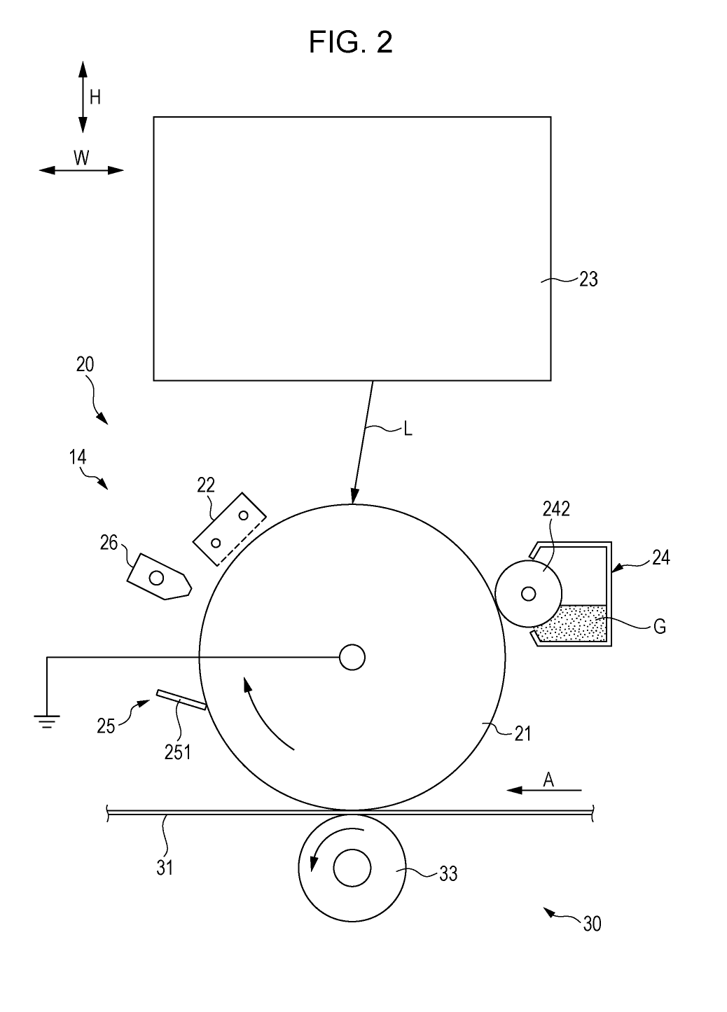

The toner image forming units 20 for the respective colors basically have structures similar to or the same as one another except for the toners used therein. Specifically, as illustrated in FIG. 2, each of the toner image forming units 20 for the colors includes a photoconductor drum 21 and a charger 22. The photoconductor drum 21 is rotated clockwise in FIG. 2. The charger 22 charges the photoconductor drum 21. Each of the toner image forming units 20 for the colors further includes an exposure device 23, a developing device 24, a cleaner 25, and a static eliminator 26. The exposure device 23 causes the photoconductor drum 21 having been charged by the charger 22 to be exposed to light so as to form an electrostatic latent image on the photoconductor drum 21. The developing device 24 develops the electrostatic latent image having been formed on the photoconductor drum 21 by the exposure device 23 so as to form a toner image.

### Developing Devices

As illustrated in FIG. 2, each of the developing devices 24 includes a container 241 and a developing roller 242. Developer G is contained in the container 241. Due to a potential difference generated between the developing roller 242 and the photoconductor drum 21 by applying a developing bias voltage to the developing roller 242, the electrostatic latent image formed on an outer circumferential surface of the photoconductor drum 21 becomes visible as a toner image.

### Cleaner

Each of the cleaners 25 includes a blade 251. The toner remaining on the surface of a corresponding one of the photoconductor drums 21 after the toner image has been transferred to the transfer device 30 is scraped off from the surface of the photoconductor drum 21 by the blade 251.

### Transfer Device

The transfer device 30 transfers the toner images of the photoconductor drums 21 for the colors to a transfer belt 31 (first transfer body) through first transfer at first transfer positions T such that the toner images are superposed on one another. The superposed toner images are transferred onto the recording media P through second transfer at a second transfer position NT. Specifically, the transfer device 30 includes the transfer belt 31, first transfer rollers 33, a second transfer roller 34, which serves as an example of a transfer member.

### Transfer Belt

The transfer belt 31 is an endless belt looped over plural rollers 32 as illustrated in FIG. 1. Out of the plural rollers 32, a roller 32D functions as a drive roller that rotates the transfer belt 31 in an arrow A direction with power from a motor (not illustrated). By rotating the transfer belt 31 in the arrow A direction, the toner images having been transferred at the respective first transfer positions T through first transfer so as to be superposed on one another are transported to the second transfer position NT.

Out of the plural rollers 32, a roller 32T functions as a tension applying roller that applies tension to the transfer belt 31, and a roller 32B functions as a facing roller 32B that faces the second transfer roller 34.

A cleaner 35, which cleans the transfer belt 31, is disposed downstream of the second transfer position NT and upstream of the first transfer position T (V) in a direction (arrow A direction) in which the transfer belt 31 is rotated. The cleaner 35 includes a blade 351. The toner remaining on the surface of the transfer belt 31 is scraped off from the surface of the transfer belt 31 by the blade 351.

### First Transfer Rollers

The first transfer rollers 33, which are disposed inside the transfer belt 31, transfer toner images on the respective photoconductor drums 21 onto the transfer belt 31. Each of the first transfer rollers 33 faces a corresponding one of the photoconductor drums 21 for the colors with the transfer belt 31 interposed therebetween. By applying a first transfer voltage, the polarity of which is opposite to the polarity of the toner, to each of the first transfer rollers 33, the toner image formed on the photoconductor drum 21 is transferred onto the transfer belt 31 at a corresponding one of the first transfer positions T. Second Transfer Roller

The second transfer roller 34 transfers the toner images superposed on one another on the transfer belt 31 onto the recording medium P. The second transfer roller 34 is disposed such that the transfer belt 31 is interposed between the second transfer roller 34 and the aforementioned facing roller 32B facing the second transfer roller 34. The second transfer roller 34 and the transfer belt 31 are in contact with each other at a predetermined load. A nip between the second transfer roller 34 and the transfer belt 31 that are in contact with each other in such a manner is the second transfer position NT. The recording medium P is supplied from the container unit 51 to the second transfer position NT at appropriate timing.

### Fixing Device

The fixing device 40 fixes the toner images onto the recording medium P onto which the toner images have been transferred. Specifically, the fixing device 40 includes a fixing belt 411, which is looped over plural rollers 413, and a pressure roller 42. The toner images are heated while being pressed in a fixing nip NF formed between the fixing belt 411 and the pressure roller 42 so as to be fixed onto the recording medium P.

### Image Forming Operation

Next, an outline of image forming steps and after-treatment steps performed on the recording medium P by the image forming apparatus 10 is described.

Referring to FIG. 1, in response to an image forming instruction, the controller 70 causes the toner image forming units 20, the transfer device 30, and the fixing device 40 to operate. The controller 70 also causes the transport device 50 and so forth in synchronization with the operations of the toner image forming units 20, the transfer device 30, and the fixing device 40.

The photoconductor drums 21 for the colors are charged by the respective chargers 22 while being rotated. The controller 70 causes image data having undergone image processing performed by an image signal processing unit to be transmitted to the exposure devices 23. Each of the exposure devices 23 radiates exposure light L (see FIG. 2) in accordance with the image data so as to cause a corresponding one of the charged photoconductor drums 21 to be exposed to the exposure light L. Thus, an electrostatic latent image is formed on an outer circumferential surface of each of the photoconductor drums 21. The electrostatic latent images formed on the photoconductor drums 21 are developed by the respective developing devices 24. Thus, the toner images of the first special color (V), the second special color (W), yellow (Y), magenta (M), cyan (C), and black (K) are formed on the photoconductor drums 21 for the respective colors.

The toner images of the colors formed on the photoconductor drums 21 for the respective colors are sequentially transferred onto the rotating transfer belt 31 by the first transfer rollers 33 for the respective colors at the respective first transfer positions T through first transfer. Thus, superposed toner images made of the toner images of the six colors are formed on the transfer belt 31. These superposed toner images are transported to the second transfer position NT by rotation of the transfer belt 31. The recording medium P is fed to this second transfer position NT by the transport rollers 52 at timing adjusted to transportation of the superposed toner images. The superposed toner images are transferred from the transfer belt 31 onto the recording medium P at this second transfer position NT through second transfer.

The recording medium P onto which the toner images have been transferred through second transfer is transported toward the fixing device 40 by the transport belts 58 while being sucked to the transport belts 58 by a negative pressure. The fixing device 40 applies heat and pressure to the recording medium P passing through the fixing nip NF. Thus, the toner images having been transferred onto the recording medium P are fixed onto the recording medium P.

The recording medium P onto which the toner images have been fixed by the fixing device 40 is transported by the transport belt 54 and ejected to the ejection unit (not illustrated).

### Configuration of the Elements

Next, the “silver toner” used for the first special color (V), toners of the colors other than silver used for the second special color (W), yellow (Y), magenta (M), cyan (C), and black (K) (may be simply referred to as “toners of the other colors” hereafter), and so forth are described in detail.

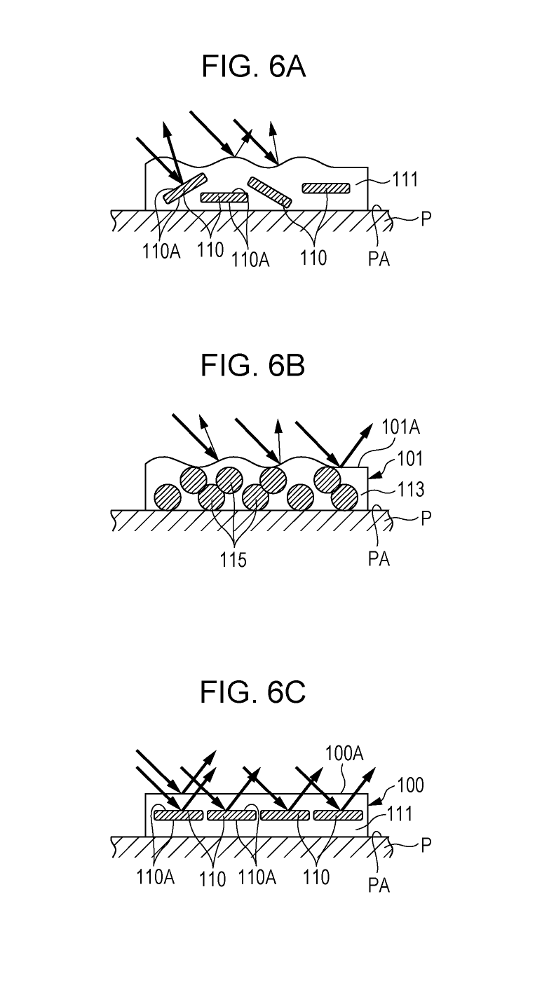

As illustrated in FIG. 3B, the silver toner used for the first special color (V) includes pigment particles 110 each serving as an example of a flat pigment and binder resin 111. The silver toner is used when giving a metallically glossy appearance to images. The images to which the metallically glossy appearance is given include images formed only of the silver toner (see FIG. 6C, which illustrates an image 100 formed only of the silver toner) and images formed of the silver toner and toners other than the silver toner.

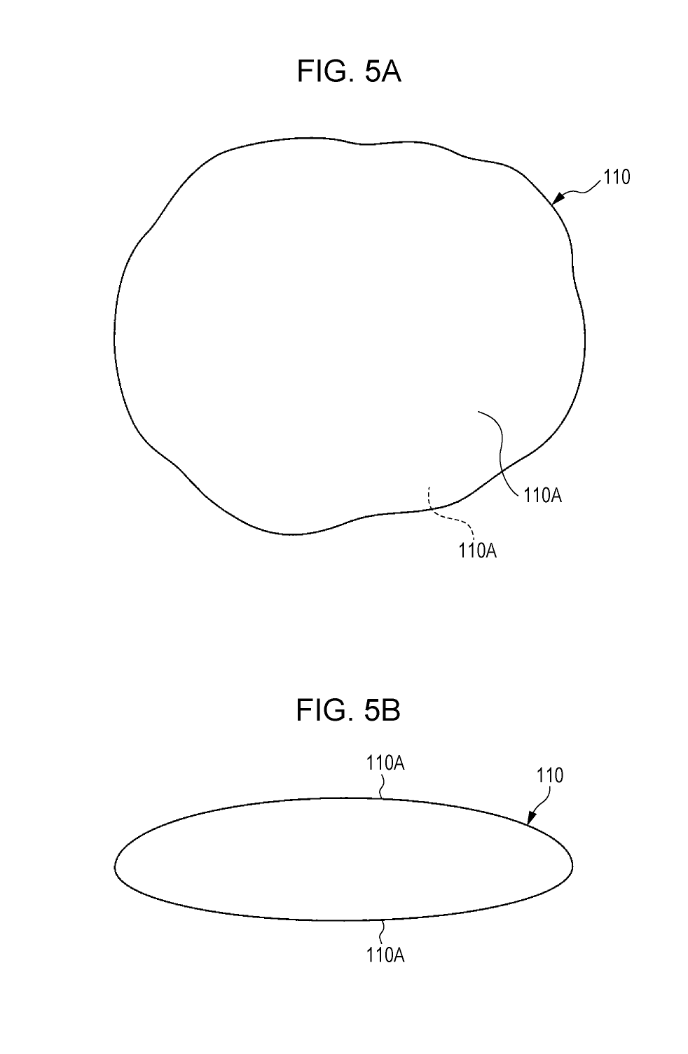

The pigment particles 110 are made of aluminum. Furthermore, as illustrated in FIG. 5B, when one of the pigment particles 110 is placed on a flat surface and seen from a side, the dimensions of the pigment particle 110 are long in the horizontal direction than in the vertical direction of the page of FIG. 5B.

Furthermore, when the pigment particle 110 illustrated in FIG. 5B is seen from above in FIG. 5B, the shape of the pigment particle 110 is enlarged compared to that seen from the side as illustrated in FIG. 5A. Furthermore, in the state in which the pigment particle 110 is placed on the flat surface (see FIG. 5B), the pigment particle 110 has a pair of reflective surfaces 110A (flat surfaces). One and the other of the pair of reflective surfaces 110A respectively face upward and downward. As has been described, the pigment particles 110 have a flat shape.

As illustrated in FIG. 6B, the toners of the colors other than silver (toners of the other colors), that is, the toners of the second special color (W), yellow (Y), magenta (M), cyan (C), and black (K) include binder resin 113 and pigment particles 115 (for example, organic pigment particles or inorganic pigment particles) other than flat pigment particles. Although the flat pigment particles have a spherical (circular) shape in FIG. 6B, this is not an exact illustration of the shape of the actual pigment particles 115. The reason for this is that FIG. 6B is schematically illustrated for clear understanding of the difference between the pigment particles 115 and the flat-shaped pigment particles 110.

Here, a minimum fixing temperature (MFT) is a physical property of toner (toner characteristic) with which a toner image is fixed onto the recording medium P, and the minimum fixing temperature of the silver toner is lower than those of the toners of the other colors.

More specifically, in the present exemplary embodiment, the minimum fixing temperature of the silver toner is lower than those of the toners of the other colors by 3° C. or more. That is,

minimum fixing temperature of silver toner +3° C. minimum fixing temperature of any of toners of other colors.

The minimum fixing temperature is adjustable in the design of toner. In the present exemplary embodiment, the minimum fixing temperature is adjusted by changing the viscoelastic moduli of the binder resins 111 and 113 of the toners of the colors.

The method of measuring the minimum fixing temperature will be described later.

### Operations of the Elements

Next, operations of the elements are described.

In response to an image forming instruction instructing that the metallically glossy appearance is given to at least part of an image (instructing that the silver toner is used), the controller 70 causes the toner image forming unit 20V for the silver toner (serving as an example of a first image forming unit) to be operated similarly to or in the same manner as the toner image forming units 20 for the toners of the other colors (each serving as an example of a second image forming unit) as illustrated in FIG. 2.

Specifically, an electrostatic latent image corresponding to part of an image where the metallically glossy appearance is given is formed on the surface of a photoconductor drum 21V. That is, in order to give the metallically glossy appearance to the entirety of the recording medium P, the electrostatic latent image is formed in the entirety of the surface of the photoconductor drum 21V, and in order to partially give the metallically glossy appearance, the electrostatic latent image corresponding to the part is formed.

The electrostatic latent image formed on the photoconductor drum 21V is developed by developer G including the silver toner supplied from the developing device 24V. Thus, the silver toner image has been formed on the photoconductor drum 21V.

This silver toner image is transferred onto the rotating transfer belt 31. Furthermore, after the silver toner image has been transferred onto the transfer belt 31, the toner images of the other colors are sequentially transferred onto the transfer belt 31. Thus, superposed toner images made of the toner images of the six colors are formed on the transfer belt 31. The superposed toner images (simply referred to as the “toner image” hereafter) are transferred from the transfer belt 31 onto the recording medium P at the second transfer position NT.

The recording medium P onto which the toner image has been transferred is transported from the transfer nip NT of the transfer device 30 toward the fixing device 40 by the transport belts 58. The fixing device 40 applies heat and pressure to the recording medium P passing through the fixing nip NF. Thus, the toner image having been transferred onto the recording medium P is fixed onto the recording medium P.

Here, as described above, the minimum fixing temperature of the silver toner is lower than those of the toners of the other colors. For this reason, at the same fixing temperature, the binder resin 111 of the silver toner is more softened than the binder resin 113 of the toners of the other colors, and accordingly, the silver toner is easily flows. Since the silver toner is easily flows, the pigment particles 110 included in the silver toner easily move.

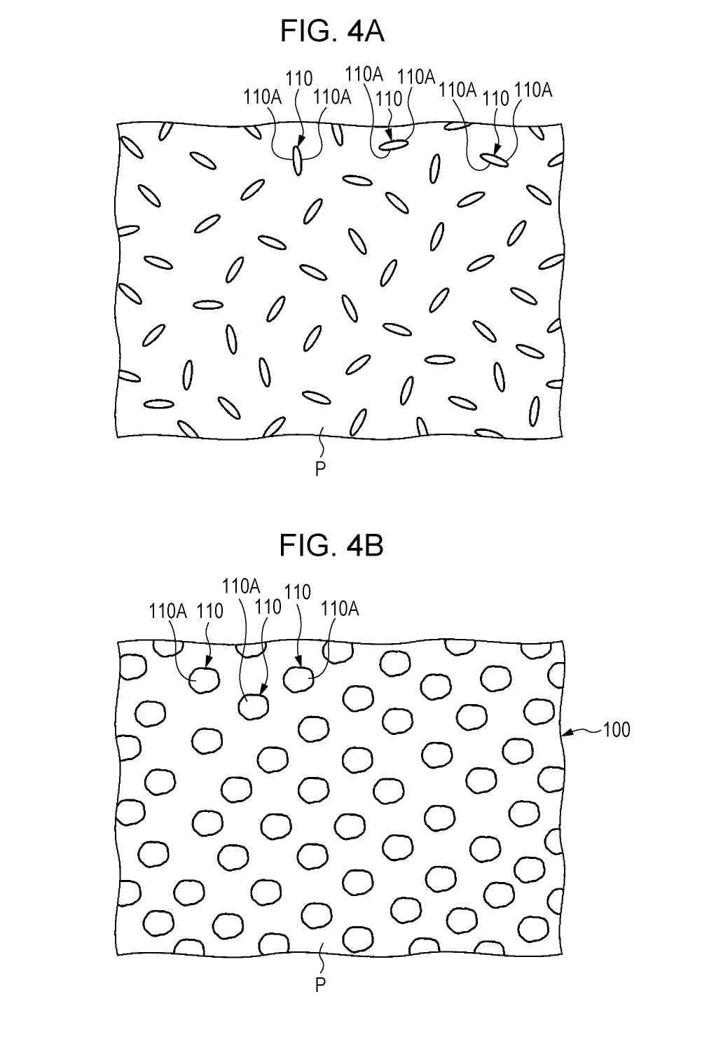

In this state, by causing the pressure roller 42 to apply pressure to the toner image in a direction toward the fixing belt 411, the reflective surfaces 110A of the pigment particles 110 face in a direction perpendicular to a sheet surface PA of the recording medium P (X direction in FIG. 3B) as illustrated in FIGS. 3B and 6C. Furthermore, the pigment particles 110 are arranged in a direction along the sheet surface PA of the recording medium P (Y direction in FIG. 3B) as illustrated in FIGS. 3B and 6C. The pigment particles 110 arranged in the direction along the sheet surface PA of the recording medium P are, as illustrated in FIG. 4B, evenly distributed on the recording medium P.

As illustrated in FIGS. 3B and 6C, the reflective surfaces 110A of the pigment particles 110 are arranged in the direction along the sheet surface PA with the reflective surfaces 110A of the pigment particles 110 facing in the direction perpendicular to the sheet surface PA. That is, the reflective surfaces 110A of the pigment particles 110 may assume positions in which directions of the reflective surfaces 110A of the pigment particles 110 follow the direction of the sheet surface PA of the recording medium P. In this case, the direction of light reflected by the image 100 more closely follows the direction perpendicular to the sheet surface PA of the recording medium P than in the case where the reflective surfaces 110A of the pigment particles 110 face in non-uniform directions as illustrated in FIGS. 3A and 6A.

This may improve the flop index (FI), which is an index measured in accordance with American Society for Testing and Materials (ASTM) E2194 and represents the metallically glossy appearance (that is, may improve the metallically glossy appearance).

By setting the minimum fixing temperature of the silver toner to be lower than those of the toners of the other colors as described above, the reflective surfaces 110A of the pigment particles 110 may assume the positions in which the directions of the reflective surfaces 110A of the pigment particles 110 follow the direction of the sheet surface PA of the recording medium P, and accordingly, the flop index representing the metallically glossy appearance may be improved (the metallically glossy appearance may be improved).

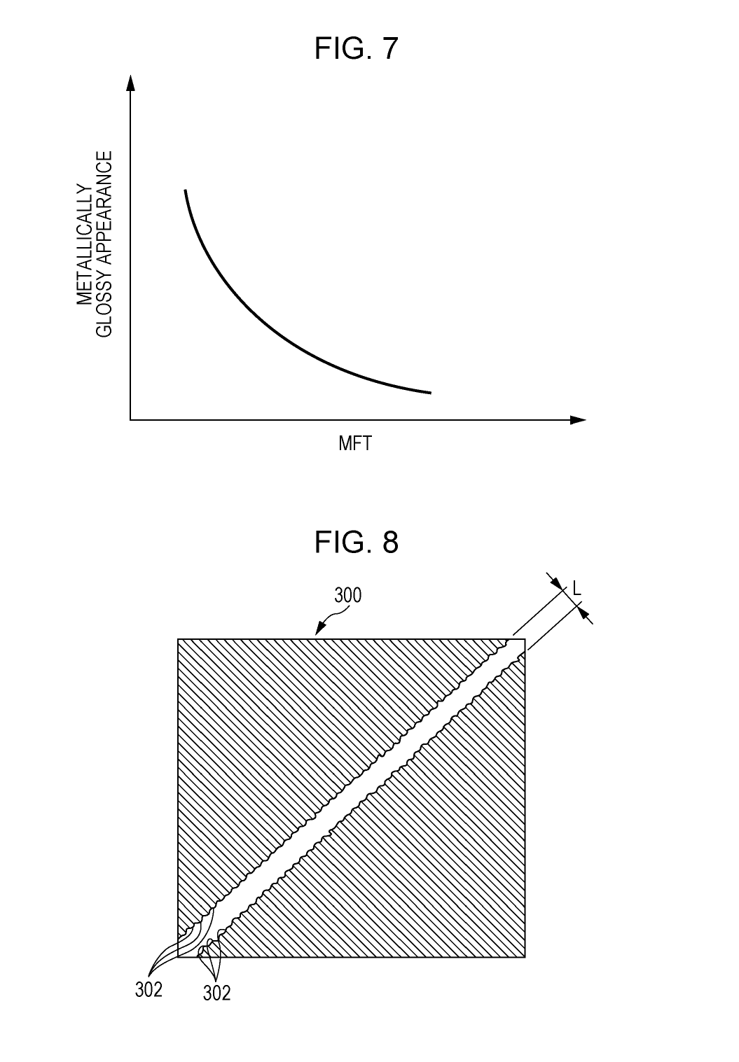

FIG. 7 is a graph illustrating the relationship between the minimum fixing temperature and the metallically glossy appearance. More specifically, the graph illustrated in FIG. 7 represents that, as the minimum fixing temperature decreases, the binder resin 111 of the toner is further softened, and accordingly, the toner easily flows. This makes it easy for the pigment particles 110 to move. Thus, the reflective surfaces 110A of the pigment particles 110 may assume the positions in which the directions of the reflective surfaces 110A of the pigment particles 110 follow the direction of the sheet surface PA of the recording medium P. This may increase the metallically glossy appearance.

Furthermore, in the present exemplary embodiment, the minimum fixing temperature of the silver toner is lower than those of the toners of the other colors by 3° C. or more. Thus, the flop index may increase by equal to or more than 1. It is noted that when the difference in the flop index is equal to or more than 1, the difference in the metallically glossy appearance is considered to be visually recognizable.

The fact that the difference of equal to or more than 1 in the flop index is caused by the difference of equal to or more than 3° C. in the minimum fixing temperature will be described later.

As illustrated in FIG. 4B, the pigment particles 110 having the reflective surfaces 110A that face in the direction perpendicular to the sheet surface PA are evenly distributed on the recording medium P. Thus, a covering ratio, at which the recording medium P is covered by the pigment particles 110, is improved compared to the case as illustrated in FIG. 4A where the pigment particles 110 having the reflective surfaces 110A that face in non-uniform directions are arranged on the recording medium P. In other words, a reflecting area, by which light incident upon the surface of the recording medium P is reflected by the pigment particles 110, is increased. This may also increase the flop index.

Furthermore, a surface 100A of the image 100 of the silver toner illustrated in FIG. 6C is smoothed more than a surface 101A of an image 101 of the toners of the other colors illustrated in FIG. 6B. Thus, there is the difference in smoothness (surface property) between the image 100 of the silver toner and the image 101 of the toners of the other colors. This may improve the relative (sensory) metallically glossy appearance of the image 100 of the silver toner compared to the toners of the other colors. Method of Measuring Minimum Fixing Temperature

Next, a method of measuring the minimum fixing temperature of toner is described.

An outline of the measurement method is as follows: an unfixed solid image is formed on the recording medium P and fixed by a temperature-variable external fixing device; then, a fold line is formed in the fixed solid image with a tool (in the present example, a pressure roller as will be described later) with which a predetermined load (pressure) is applied to the recording medium P; and when an image defect at the fold line of an fixed solid image fixed at a temperature becomes less than a predetermined degree of defect, the fixing temperature at which this image is fixed is regarded as the minimum fixing temperature. Output machine of unfixed solid image
A commercial electrophotographic copier (A modified Color 1000 Press (by Fuji Xerox Co., Ltd.) External fixing device
A belt nip method device
Dwell time (nip width (mm)/fixing speed (mm/s)): 0.054 Other evaluation tools
A pressure roller: 28 ounces (792 g) in weight
Dry and clean rayon wool
A dedicated toner wiping tool (load: 120 g)
Paper by Fuji Xerox Co., Ltd. (J paper) Measurement method

(1) A 25 mm×25 mm (toner amount adjusted to 0.9 mg/m²) unfixed solid image 300 (see FIG. 8) is formed on a recording medium (paper by Fuji Xerox Co., Ltd. (J paper)).

(2) The solid image 300 is fixed onto the recording medium P by the external fixing device.

(3) The recording medium is gently diagonally bent 45° with the solid image 300 inside. At this time, attention is paid not to manually form a fold line.

(4) The bent recording medium is placed on a hard surface such as a table. The pressure roller is rolled at a certain speed so as to be reciprocated once to form a fold line. At this time, attention is paid so that the pressure is applied only by the self-weight of the pressure roller.

(5) The recording medium is opened so that the folded line is exposed. At this time, a bend is manually corrected so that the recording medium becomes as flat as possible.

(6) Toner removed by forming the fold line is wiped off. Attention is paid not to further remove the toner while wiping off the toner. In this measurement, a dedicated tool with the dry clean rayon wool attached is reciprocated once to wipe off the toner. By wiping off the toner only with the self-weight of the dedicated tool, further removal of the tone is almost prevented.

(7) The width of the toner removed by forming the fold line (width of the hollow image) in the solid image 300, that is, a crease width L (see FIG. 8) is measured. At this time, irregularities such as projections 302 (see FIG. 8) of serrated lines are averaged and measured instead of being ignored. Specifically, virtual lines that pass through central positions between peaks and bottoms of the projections 302 of the serrated lines are drawn and the crease width L is measured by, for example, a micrometer.

(8) The fixing temperature of the external fixing device is varied and the above-described steps (1) to (7) are repeated.

(9) A fixing temperature at which the crease width L becomes less than 0.6 mm is regarded as the minimum fixing temperature.

### Relationship Between Difference in Minimum Fixing Temperature and Flop Index

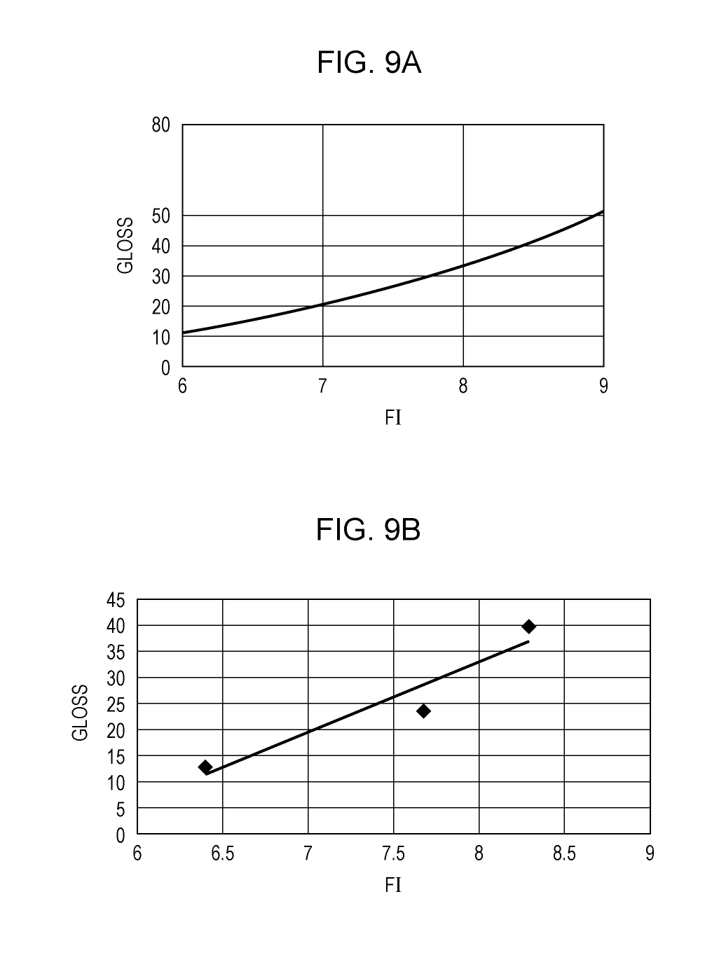

FIGS. 9A and 9B are graphs illustrating the relationship between the flop index and the gloss (glossiness) of an image formed of the silver toner under predetermined conditions (in the present example, the fixing speed is 455 mm/sec and the fixing temperature is 155° C.)

Gloss may be measured with a gloss meter. In the present example, micro-tri-gloss meter-gloss 60° by Byk gardner is used. In Japanese Industrial Standards (JIS), a glass surface (refractive index thereof is 1.567 in the entire range of visible wavelength) is defined as 100% glossiness. Also, the JIS define that, when light is incident upon a glass surface having a refractive index of 1.567, a reflectivity of 10% at an incident angle of 60° is a glossiness of 100 (%) and a reflectivity of 5% at an incident angle of 20° is a glossiness of 100 (%). Regarding the unit of gloss (glossiness), gloss (glossiness) may be expressed as a percent or simply a number according to the JIS. Also according to the JIS, it is required, in principle, a measurement angle and the manufacturer and the type of a measurement device are clearly stated.

FIG. 9B is a graph in which a range of the flop index around a target value, 7, is enlarged and a regression line is drawn. It is understood from this graph (regression line) that an increase of 1 in the flop index increases gloss by about 13. As described above, when the difference in the flop index is equal to or more than 1, the difference in the metallically glossy appearance is considered to be visually recognizable.

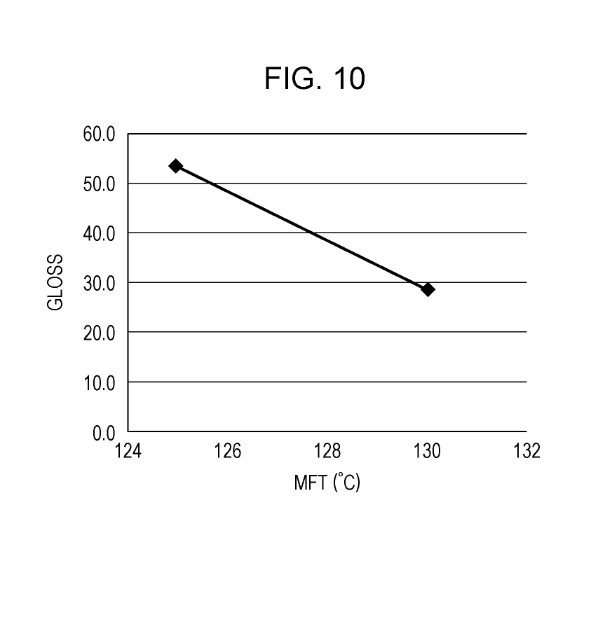

FIG. 10 is a graph illustrating the relationship between the minimum fixing temperature and the gloss. It is understood from this graph that a difference of about 3° C. in the minimum fixing temperature causes a difference of about 13 in the gloss. That is, a difference of 3° C. or more in the minimum fixing temperature causes a difference of about 13 in gloss which may be determined to be a visually recognizable difference in the metallically glossy appearance corresponding to a difference of 1 or more in the flop index.

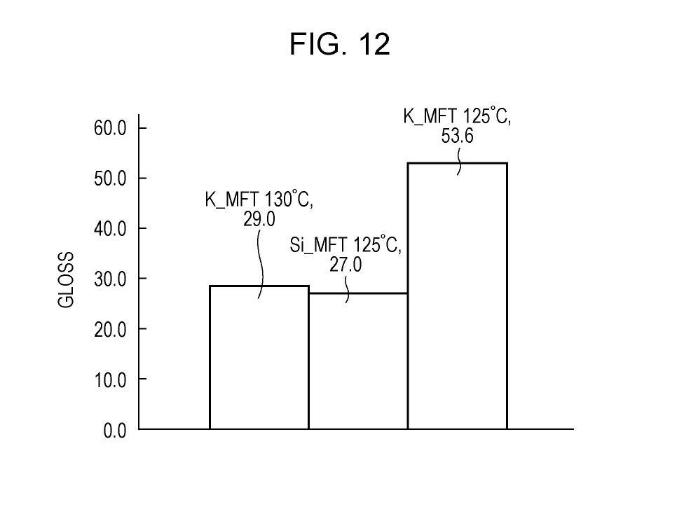

FIG. 12 is a graph illustrating the relationship between the minimum fixing temperatures and the gloss of the silver toner (Si) and toner of another color (black (K) in the present example) according to the present exemplary embodiment.

### Summarization of the Elements

As has been described, by setting the minimum fixing temperature of the silver toner to be lower than those of the toners of the other colors, the reflective surfaces 110A of the pigment particles 110 may assume the positions in which the directions of the reflective surfaces 110A of the pigment particles 110 follow the direction of the sheet surface PA of the recording medium P.

By setting the pigment particles 110 in such positions that the directions of the reflective surfaces 110A of the pigment particles 110 follow the direction of the sheet surface PA of the recording medium P, the flop index may be improved, that is, the metallically glossy appearance may be improved.

Furthermore, the minimum fixing temperature of the silver toner is lower than those of the toners of the other colors by 3° C. or more. Thus, the flop index may be improved to such a degree that the difference in metallically glossy appearance is visually recognizable.

### Second Exemplary Embodiment

Next, an example of the image forming apparatus according to a second exemplary embodiment of the present invention will be described. The same elements as those in the first exemplary embodiment are denoted by the same reference signs and description thereof is omitted. The features of the second exemplary embodiment different from those of the first exemplary embodiment are described.

### Configuration

In response to the image forming instruction instructing that the metallically glossy appearance is given to at least part of a toner image, the controller 70 illustrated in FIG. 1 controls the fixing device 40 so as to increase the amount of heat applied to the toner image when fixing the toner image compared to the case where the controller 70 receives an image forming instruction instructing that the metallically glossy appearance is not given to an image. Specifically, the controller 70 controls the fixing device 40 so as to change at least one of the fixing temperature, the fixing pressure, and the fixing time, thereby increasing the heat amount given to the toner image when fixing the toner image.

### Operations

Next, operations are described.

In response to the image forming instruction instructing that the metallically glossy appearance is given to at least part of an image, the controller 70 controls the fixing device 40 so as to increase the heat amount applied to the toner image when fixing the toner image compared to the case where the controller 70 receives an image forming instruction instructing that the metallically glossy appearance is not given to an image.

In other words, in order to fix the toner image formed on the recording medium P using the toner including the pigment particles 110 onto the recording medium P, the controller 70 causes the heat amount applied to the toner image to be increased when fixing the toner image compared to the case where the toner image formed on the recording medium P using only the toner or the toners not including the pigment particles 110 is fixed onto the recording medium P.

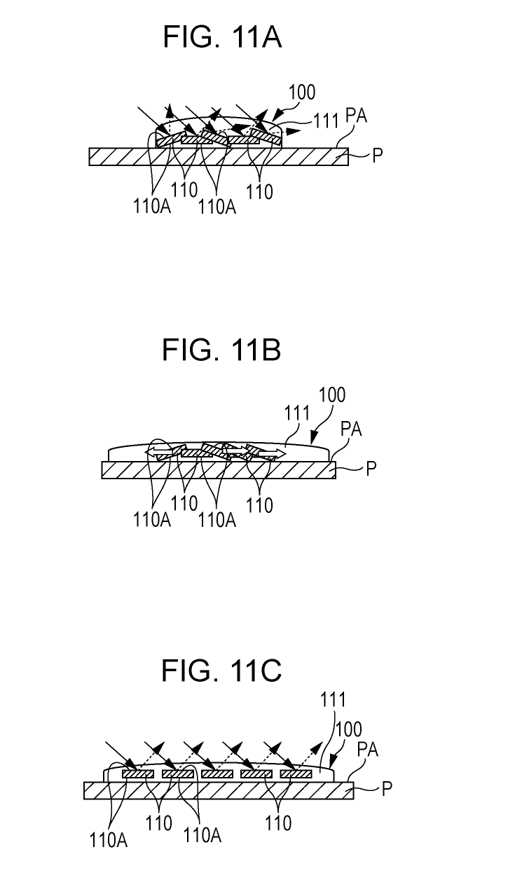

The resin binder included in the toner is softened by increasing the heat amount applied when fixing the toner image onto the recording medium P as described above. As illustrated in FIG. 11B, this further facilitates movements of the flat pigment particles 110 included in the silver toner.

When the toner image is fixed in this state, a direction in which the reflective surfaces 110A of the pigment particles 110 face more closely follows the direction perpendicular to the sheet surface PA of the recording medium P and a direction in which the pigment particles 110 are arranged more closely follows the direction along the sheet surface PA of the recording medium P as illustrated in FIG. 11C (also see FIGS. 3B and 6C) than in the case where the heat amount is not increased (see FIG. 11A). That is, the reflective surfaces 110A of the pigment particles 110 may assume the positions in which the directions of the reflective surfaces 110A of the pigment particles 110 more closely follow the direction of the sheet surface PA of the recording medium P than in the case where the heat amount is not increased.

As described above, by increasing the heat amount applied to the toner image when fixing the toner image under the control of the controller 70 in the case where the metallically glossy appearance is given to at least part of the image compared to the case where the metallically glossy appearance is not given to the image, the reflective surfaces 110A of the pigment particles 110 may assume the positions in which the directions of the reflective surfaces 110A of the pigment particles 110 more closely follow the direction of the sheet surface PA of the recording medium P than in the case where the heat amount is not increased. When the reflective surfaces 110A of pigment particles 110 assume the positions in which the directions of the reflective surfaces 110A of the pigment particles 110 more closely follow the direction of the sheet surface PA of the recording medium P than in the case where the heat amount is not increased, the flop index may further increase and the metallically glossy appearance may be further improved.

Description of the other operations which are similar to or the same as those of the first exemplary embodiment is omitted.

### Variations

In the present exemplary embodiment, the colors of the toners other than that of the silver toner are the following five colors: that is, the second special color (W), yellow (Y), magenta (M), cyan (C), and black (K). The minimum fixing temperatures of the toners of these five other colors are substantially the same. However, in the case where there are slight differences in the minimum fixing temperature between the toners of the five colors, the minimum fixing temperature of the silver toner may be set to be lower than the lowest minimum fixing temperature among the minimum fixing temperatures of the toners of the five colors other than the silver toner. Furthermore, the minimum fixing temperature of the silver toner is preferably lower than the lowest minimum fixing temperature among the minimum fixing temperatures of the toners of the five colors other than the silver toner by 3° C. or more.

Furthermore, as the difference in the minimum fixing temperature between the silver toner and the toners of the other colors increases, the reflective surfaces 110A of the pigment particles 110 may assume the positions in which the directions of the reflective surfaces 110A of the pigment particles 110 closely follow the direction of the sheet surface PA of the recording medium P. Thus, from the viewpoint of causing the reflective surfaces 110A of the pigment particles 110 to assume the positions in which the directions of the reflective surfaces 110A of the pigment particles 110 follow the direction of the sheet surface PA of the recording medium P, the difference in the minimum fixing temperature between the silver toner and the toners of the other colors may be increased as much as possible in a range in which defects such as hot offset do not occur.

Although the first special color (V) is silver in the above-described exemplary embodiments, this does not limit the first special color (V). The first special color (V) may be a metallic color other than silver, for example, gold. Although the second special color (W) is a user specific corporate color in the above-described exemplary embodiments, the second special color (W) may be a metallic color for giving the metallically glossy appearance. For example, the first special color (V) may be silver and the second special color (W) may be gold.

Although the specific embodiments of the present invention have been described in detail, the present invention is not limited to these embodiments. Obviously, those skilled in the art understand that various other embodiments are possible within the scope of the present invention. For example, in the example for explaining the above-described exemplary embodiments, the toner images of the colors are separately transferred onto the transfer belt 31. However, each of the toner images of the colors may be separately directly transferred onto the recording medium P, or the toner images of the colors may be collectively transferred onto the transfer belt 31 or the recording medium P.

Although the silver toner image and the toner images of the other colors are simultaneously fixed onto the recording medium P in the above-described exemplary embodiments, fixing of the silver toner image onto the recording medium P and fixing of the toner images of the other colors onto the recording medium P may be separately performed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first image forming unit that uses a toner including a flat pigment;
a second image forming unit that uses a toner not including a flat pigment; and
a fixing unit that fixes a toner image formed on a recording medium by heat,
wherein a minimum fixing temperature of the toner including the flat pigment is lower than a minimum fixing temperature of the toner not including the flat pigment.

2. The image forming apparatus according to claim 1,
wherein the minimum fixing temperature of the toner including the flat pigment is lower than the minimum fixing temperature of the toner not including the flat pigment by 3° C. or more.

3. The image forming apparatus according to claim 1, further comprising:
a controller that controls a heat amount applied to the image by the fixing unit depending on whether or not the toner including the flat pigment is used for the image,
wherein, when fixing the image, in a case where the image has been formed on the recording medium with the toner including the flat pigment, the controller causes the heat amount applied to the image by the fixing unit to be increased compared to a case where the image has been formed on the recording medium P with the toner not including the flat pigment.

4. An image forming apparatus comprising:
a first image forming unit that forms a toner image using a toner including a flat pigment;
a second image forming unit that forms a toner image using at least one of yellow, magenta, cyan, and black colored toners;
a transfer unit that transfers both toner images onto a recording medium; and
a fixing unit that fixes both the toner images transferred onto the recording medium by heat,
wherein a minimum fixing temperature of the toner used in the first image forming unit is lower than a minimum fixing temperature of the toner used in the second image forming unit.
